(19) United States
(12) Patent Application Publication
(10) Pub. No.: US 2025/0367891 A1
(43) Pub. Date: Dec. 4, 2025

(54) Resin Transfer Molding Vent Bleeder Valve

(71) Applicant: R&D Innovations, LLC, Nashville, NC (US)

(72) Inventor: Daniel Christopher Long, Nashville, NC (US)

(73) Assignee: R&D Innovations, LLC, Nashville, NC (US)

(21) Appl. No.: 19/226,080

(22) Filed: Jun. 2, 2025

Related U.S. Application Data
(60) Provisional application No. 63/655,263, filed on Jun. 3, 2024.

(51) Int. Cl. B29C 70/48; B29C 33/10; B29C 70/54; F16K 15/04; F16K 15/06

(52) U.S. Cl. CPC B29C 70/48; B29C 33/10; B29C 70/54; F16K 15/044; F16K 15/063

(57) ABSTRACT

A vent bleeder valve (VBV) evacuates air while minimizing resin loss during resin transfer molding, replacing a mold's conventional push-to-fit air vent tube. The VBV allows air to freely exit the mold's resin cavity, unaccompanied by resin. A spring applies force on a closure element (“plug”), for example a ball bearing. An integrated pressure cylinder controls the operation by lifting the valve's internal assembly and adjusting the spring load on the plug. When energized, the spring load on the plug permits air bubbles to escape from the mold while preventing resin from passing through until the pressure on the plug surpasses a set spring force. When de-energized, a spring return mechanism closes the VBV, ensuring an airtight seal. The VBV can also operate in reverse (spring lift, air close), as well as in vacuum lift, vacuum close, and electromagnetic valve switching modes.

### CROSS-REFERENCE TO RELATED APPLICATIONS

This application claims the benefit of U.S. Provisional Patent Application Ser. No. 63/655,263, filed Jun. 3, 2024

### BACKGROUND

This invention relates generally to products and methods for addressing composite parts manufacturing challenges of waste and quality in the resin transfer molding process. More particularly, this invention relates to products for minimizing the loss of resin when removing entrapped air from the mold during the resin transfer molding process.

Resin transfer molding in an industrial setting is typically a low pressure and low temperature process through which a liquid thermoset resin (comprising a polymer and catalyzing agent) is injected into a closed mold, the interior shape of which matches the part to be produced. Typically, the mold has been pre-loaded with a laminate comprising a dry fiber, or some other porous reinforcing material, and the resin is pulled or pushed into the laminate or other reinforcing material through use of pressure and/or vacuum. In vacuum-assisted resin transfer molding, a partial vacuum can be placed on the cavity of the mold. When used in moderation, this pressure differential provides several benefits, including that it (1) reduces the number of air molecules (2) reduces entrapped air bubble size, and (3) encourages air molecules to stay ahead of the flow front during injection. The amount of pressure used in the mold is dependent in part on the mold material. For example, steel molds can withstand higher pressures than glass fiber molds, but glass fiber molds are more commonly used because they are far less expensive. A vacuum of 14-16 inches of Hg is not unusual for glass fiber molds.

Air trapped inside the mold at the time the mold is closed must be removed so that the resin can fully penetrate the laminate and result in an end product that has a smooth finish and does not contain significant air bubbles. To remove air bubbles and entrapped air, traditional processes rely on the injection of additional resin. As this additional resin enters the mold, it forces previously-injected resin out through one or more air vent ports, each connected to an air vent tube, pushing any trapped excess air to the outside as well. The venting process stops when no more entrapped air is expected to exit. Both manual and automated methods to manage this mold venting process are utilized, but in each case, the method requires injecting into the mold more resin than is necessary simply to fill the mold, because resin is used to carry the air through the vent port and vent tube to the exterior of the mold. The air vent tube directs the excess resin to a container where it is captured and discarded.

In manually controlled manufacturing processes, the venting process is controlled by the operator and is sensitive to personal interpretation. Mold operators may manually inspect the vent tubes for entrapped air. By crimping the vent tube and slowly releasing the built-up mold pressure, the operator is able to “feel” air bubbles as they pass the crimp. The operator may inject more resin to assist in purging out any final air bubbles. The purpose of the excess resin is to slightly increase cavity pressure and drive the remaining bubbles out of the mold. The amount of excess resin is highly variable and can range from 200 or 300 mL and up to 800 mL per vent port in a typical installation. The number of air vent ports, their location, and flow geometry, as well as mold seal quality, and even operator experience, are all among the factors that can contribute to the amount of excess resin used during the molding process. Once the operator is satisfied that enough air bubbles have come out of the mold, they clamp the vent tube and allow the part to cure.

In semi-automated and automated manufacturing processes, a computer controls the total amount of resin injected in the mold. Back-pressure at the resin injection port increases once the cavity is full. As this pressure rises, automated systems normally slow the flow to maintain a pre-specified cavity pressure, which typically is 500-600 mL more than is needed to fill the mold. This allows the extra resin to push the air bubbles out. An automated valve then closes the air vent port, and the vent tubes are purged and cleaned so they will be ready for re-use.

Even using the best of these traditional processes, entrapped air remains a leading cause of part quality issues, part scrap, and laminate failures. In addition, although methods such as obstructing the air vent port with permeable material, crimping vent tubes, and adjusting pressures may reduce the amount of resin loss to some extent, resin loss remains a significant problem because these traditional methods ultimately rely on resin to carry the air to the air vent port, and allow—indeed, in most cases rely on—the transfer of resin carrying the air through the air vent port and out the air vent tube. It is not unusual for 200 or 300 mL and up to 800 mL of resin per air vent port to be wasted during the venting process for a typical 4-foot mold, with 500-600 mL of wasted resin being common in semi-automated processes, amounting to somewhere around 5% of the total resin volume. This excess resin is wasted rather than reusable because it already contains a catalyzing agent and thus begins to harden after it is ejected and before it can be used for other purposes.

Once air has been vented, the curing process then proceeds. Whether or not a vacuum is intentionally applied, the catalyzing agent reacts with the polymer during the molding process, causing the resin to harden and solidify. This chemical process gives off heat causing a rise in part and mold temperature. Once the reinforced composite has cooled sufficiently for the part to maintain shape and dimensional accuracy, the part is removed from the mold.

### SUMMARY

Resin transfer molding (RTM) is a manufacturing process directed to producing composite parts with high strength and precise fiber reinforcement. The present invention is directed to a resin transfer molding vent bleeder valve (which may hereafter be referred to as the “vent bleeder valve” or “VBV”) that is designed to address the manufacturing waste and improve the removal of entrapped air during the resin transfer molding process.

In a low-pressure, low-temperature RTM process, the inventive vent bleeder valve addresses several manufacturing challenges. The vent bleeder valve in RTM functions as a mechanism for controlling pressure and facilitating air or excess resin removal during the molding process. Common issues associated with the RTM process include air entrapment and voids, incomplete resin flow, uneven curing, material waste, and pressure fluctuations. The present invention obviates or at least substantially minimizes these and other difficulties experienced in the low-pressure, low-temperature RTM process.

As noted above, in resin transfer molding, the mold typically has been pre-loaded with a laminate comprising a dry fiber or some other porous reinforcing material, and the resin is pulled or pushed into the laminate or other reinforcing material through the use of pressure and/or vacuum. One key performance indicator in the industry is that the quality and strength of a part or component increase as the percentage of entrapped air is reduced. The absence of air bubbles marring the surface finish also improves the appearance of the finished products. Thus, one consistent need in the resin transfer process is the removal of air from the mold during the filling step, so that resin can completely fill the mold, and no air bubbles or entrapped air remain.

The vent bleeder valve provides substantial improvement towards achieving this desirable purpose, while also reducing the amount of resin wasted by current industrial practices.

During operation of one embodiment of the invention, the vent bleeder valve opens and closes at adjustable pressures set by a compression spring on a closure device (“plug”) comprising a ball-bearing. The compression spring mechanism ensures that the valve remains closed until the pressure exceeds the spring force. In this closed position, air is allowed to escape from the mold, but the passage of resin is prevented. When the pressure within the mold exceeds the preset limit, the spring compresses, and the ball-bearing moves to open the vent bleeder valve, allowing resin, in addition to air, to vent out. Once the pressure drops below the threshold, the spring return mechanism ensures a liquid-tight seal by pushing the ball-bearing back into place, closing the vent bleeder valve.

A pressure cylinder controls the vent bleeder valve's operation by adjusting the spring load. The cylinder can be set to the precise pressure at which the vent bleeder valve opens and closes, ensuring optimal performance during the molding process. The vent bleeder valve fits liquid-tight into the mold's structure, preventing any leakage of resin. Preferably, the pressure cylinder is an integrated pressure cylinder.

The vent bleeder valve can be operated using a spring compressor or a magnetic solenoid. The spring compressor manually adjusts the spring load, while the magnetic solenoid provides an automated method of controlling the vent bleeder valve's operation. Additionally, the vent bleeder valve supports reverse operation, vacuum lift/close, and electromagnetic switching modes, offering versatility in different molding scenarios.

During reverse operation, the vent bleeder valve can be configured to open when the pressure drops below a certain level, allowing air to enter the mold. The vacuum lift/close mode utilizes a vacuum to lift the ball-bearing and open the valve, while the electromagnetic switching mode uses an electromagnetic field to control the valve's position.

### BRIEF DESCRIPTION OF THE DRAWINGS

FIG. 1 shows a front sectional cut-away perspective view of the resin transfer molding vent bleeder valve in accordance with one embodiment.

FIG. 1A shows an exploded view of the disassembled resin transfer molding vent bleeder valve depicted in FIG. 1, with its parts enclosed within a bracket, to indicate their relationship and assembly order.

FIGS. 2A-2E show views of the FIG. 1 embodiment of the resin transfer molding vent bleeder valve as follows: FIG. 2A-front elevation view, FIG. 2B-side elevation view, FIG. 2C-rear elevation view, FIG. 2D-bottom view with wrench flat, and FIG. 2E-top view with socket head.

FIGS. 3A-3C show views of the same embodiment of the resin transfer molding vent bleeder valve as depicted in FIGS. 1 and 2 in its normally closed ball-spring configuration, un-energized, along line A-A from FIG. 2C, FIG. 3B—sectional view illustrating details of inner assembly components.

FIGS. 4A-4C show views of the embodiment of the resin transfer molding vent bleeder valve substantially similar to the embodiment depicted in FIGS. 1 and 2, as follows: FIG. 4A—sectional view of ball-spring configuration, energized, along line A-A from FIG. 2C, FIG. 4B, FIG. 4B—sectional view illustrating detail of the integrated pressure cylinder, and FIG. 4C—sectional view illustrating details of inner assembly components.

FIGS. 5A-5B show an alternative embodiment of the resin transfer molding vent bleeder valve depicted in FIGS. 1 and 2, as follows: FIG. 5A—sectional view of an alternative embodiment depicting a normally closed angled poppet having a squared edge configuration, and FIG. 5B—sectional view illustrating details of the lower port entrance.

FIGS. 6A-6B show a further alternative embodiment of the resin transfer molding vent bleeder valve depicted in FIGS. 1 and 2, utilizing an alternative embodiment of a poppet, as follows: FIG. 6A—sectional view of an alternative embodiment depicting a normally closed angled poppet with a chamfered edge configuration, and FIG. 6B—sectional view illustrating details of the lower port entrance.

FIGS. 7A-7B show views a further alternative embodiment of the resin transfer molding vent bleeder valve depicted in FIGS. 1 and 2 utilizing an alternative embodiment depicting a normally closed spherical poppet having a square edge configuration, and FIG. 7B—sectional view illustrating details of the lower port entrance.

FIGS. 8A-8B show a still further alternative embodiment of the resin transfer molding vent bleeder valve depicted in FIGS. 1 and 2, utilizing yet another alternative embodiment of a poppet, as follows: FIG. 8A—sectional view of an alternative embodiment depicting a normally closed spherical poppet having a chamfer edge configuration, and FIG. 8B—sectional view illustrating details of the lower port entrance.

FIGS. 9A-9E show an example of the prior art current industrial configuration of a resin transfer mold and air vent for eliminating air from the mold, as follows: FIG. 9A-a front perspective view of a prior art push-to-connect vent tube fitting, which the inventive vent bleeder valve replaces, FIG. 9B-front elevation tubing and showing overall placement of the prior art push-to-connect vent tube fitting 902 on a resin transfer mold, FIG. 9C-front elevation view, FIG. 9D—sectional view along line A-A in FIG. 9C with detailed area 904 marking the area where the prior art push-to-connect vent tube fitting sits on a resin transfer mold, and FIG. 9E—sectional view of detail area 904 showing prior art push-to-connect vent tube fitting 902 installed in a resin transfer mold 961. FIG. 9E—sectional view illustrating details of current industrial push-to-connect vent tube fitting 902 along with vent port exit tube 964, and upper mold section 977 equipped with an interior-threaded mounting base 975 into which the prior art push-to-connect vent tube fitting 902 is seated.

FIGS. 10A-10B show an example of an embodiment of the inventive resin transfer mold vent bleeder valve installed on a typical contemporary resin transfer mold: FIG. 10A—sectional view taken along a line comparable to line A-A shown in FIG. 9C illustrating the inventive resin transfer mold vent bleeder valve installed on a resin transfer mold, FIG. 10B—sectional detail view taken from FIG. 10A showing details of the mold vent bleeder valve as installed on a mold and fitting with tubes for operation.

FIGS. 11A-11C show a further embodiment of the inventive resin transfer mold vent bleeder valve having a magnetic core within the inner assembly as follows: FIG. 11A-front elevation view, comprising a front elevational view, a side elevation view, and a sectional view along line A-A in FIG. 11B-rear elevation view, and FIG. 11C—sectional view taken along line A-A of FIG. 11B of the inventive resin transfer mold vent bleeder valve equipped with a magnetic solenoid.

### DETAILED DESCRIPTION

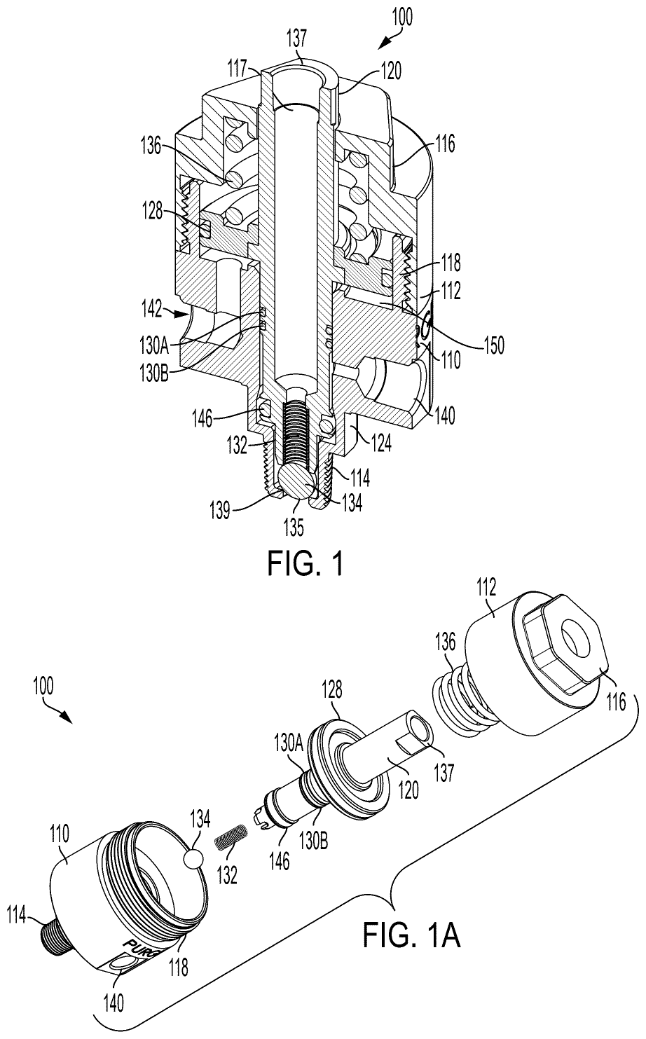

Referring to FIG. 1 and FIG. 1A, FIG. 1 illustrates a vent bleeder valve (VBV) 100, depicted in a sectional cut-away perspective view, designed for use in resin transfer molding (RTM) according to one embodiment. FIG. 1A presents an exploded view, displaying the disassembled parts, to show the relationship and order of assembly of various component parts.

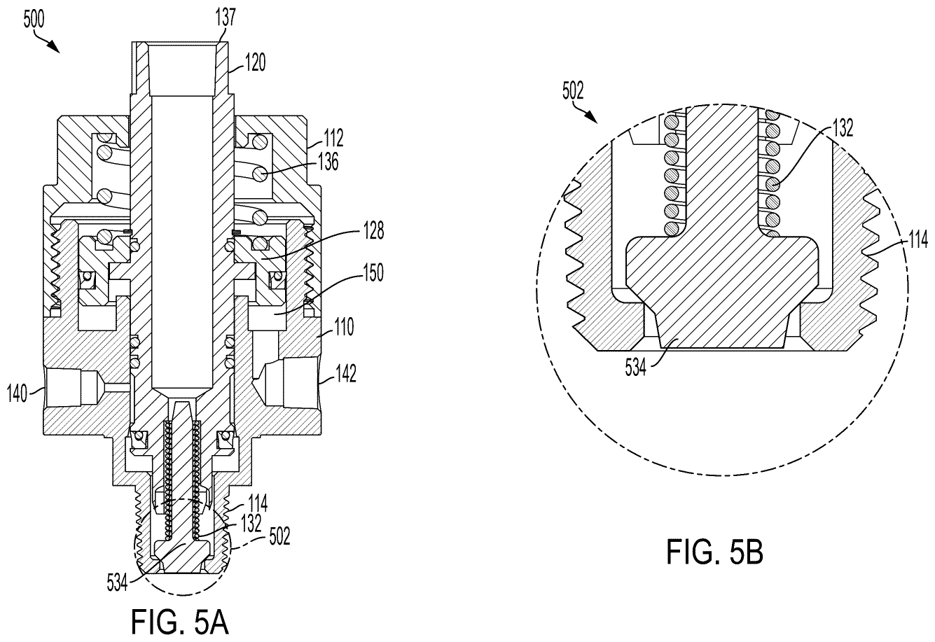

The VBV 100 plays a crucial role in RTM by facilitating the removal of air and excess resin. The VBV 100 is substantially liquid tight in all areas intended to be exposed to liquid. Its elements include a body comprised of an assembly cap 112 and a main assembly body 110, a vent passageway, vacuum chamber, or cavity 117 that comprises the interior of a valve stem 120, an air piston 128 (which may, but need not, be integrally formed with the valve stem 120, as depicted in FIG. 1; or may be formed separately but adapted to cooperate with valve stem 120 as depicted for example in FIG. 5A), a helical upper compression spring 136 (which dead-stops against assembly cap 112), a lower compression spring 132 that applies pressure to a spherical ball bearing (ball) 134, a vent port entrance 135, a vent port exit 137, and a vent port interface 139. A socket cap feature 116 is formed on the topmost end of assembly cap 112.

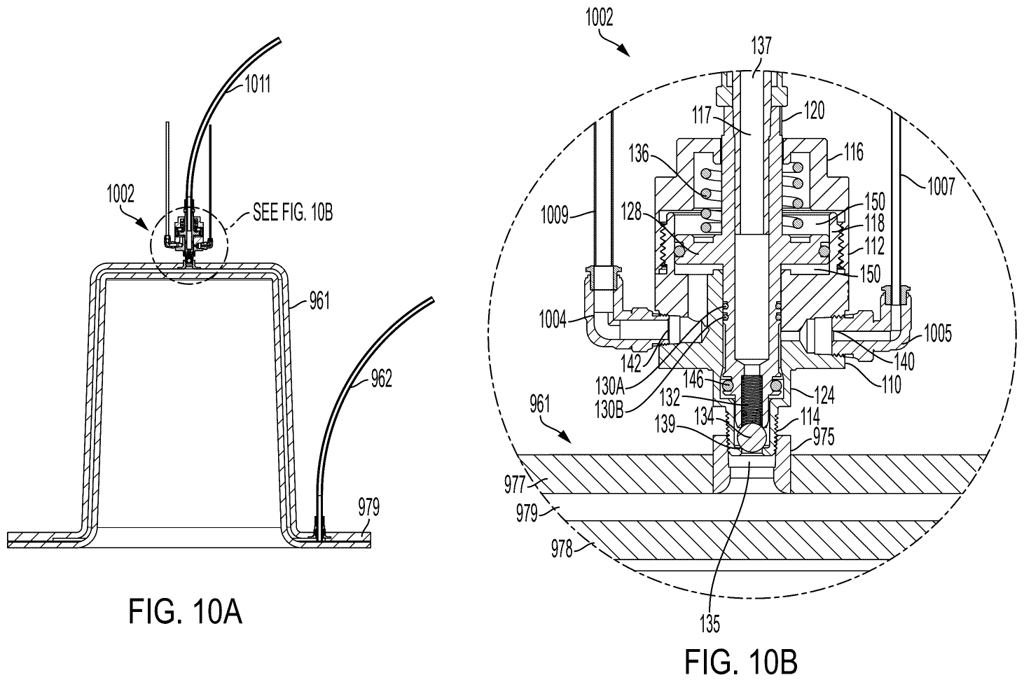

The main body 110 and assembly cap 112 form the housing that contains all the internal components of the VBV 100. The assembly cap 112 serves as the upper portion of the housing for the VBV 100, providing structural integrity and acting as a dead stop for the compression spring 136, shown as a helical compression spring. A threaded assembly connector 118 joins the assembly cap 112 with the main assembly body 110. A wrench flat feature 124 on the main assembly body 110 allows the VBV 100 to be easily installed and removed to and from a mounting base on the mold (as shown and described below with reference to FIG. 10B). This feature is designed to provide a secure grip for a tool, ensuring that the VBV 100 can be tightly fastened or loosened without damaging the VBV 100 or the mold.

An air port element 142, situated on one side of the main assembly body 110 of the VBV 100, is designed to facilitate controlled airflow during the RTM process. In addition, the air port 142 allows trapped air within the mold cavity to escape before and during resin injections. On the other side of the VBV 100 main assembly body 110 (opposite from air port element 142), a purge port (cleaning) 140 is located and functions as the point for purging and cleaning the VBV 100 of residual resin or contaminants after injection.

The VBV 100 is preassembled and inserted via an external-threaded base connector 114 into a mold's corresponding opening, the mold having a channel passage for resin and this arrangement allowing the resin to freely pass through the preform or mold. (FIG. 10B shows the base connector 114 fitting into a mold's mounting base 975 in a manner that allows the free flow of resin within the mold, as discussed below with respect to that Figure.)

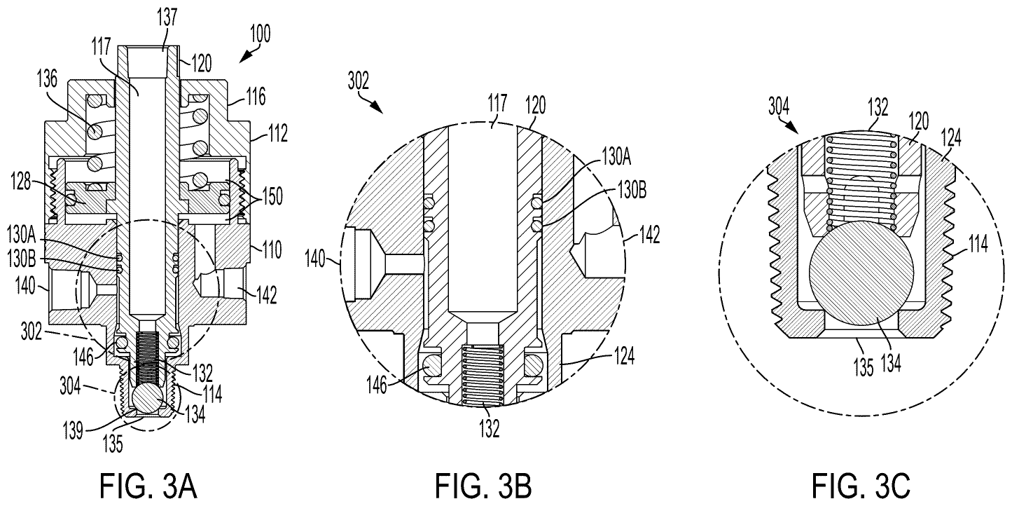

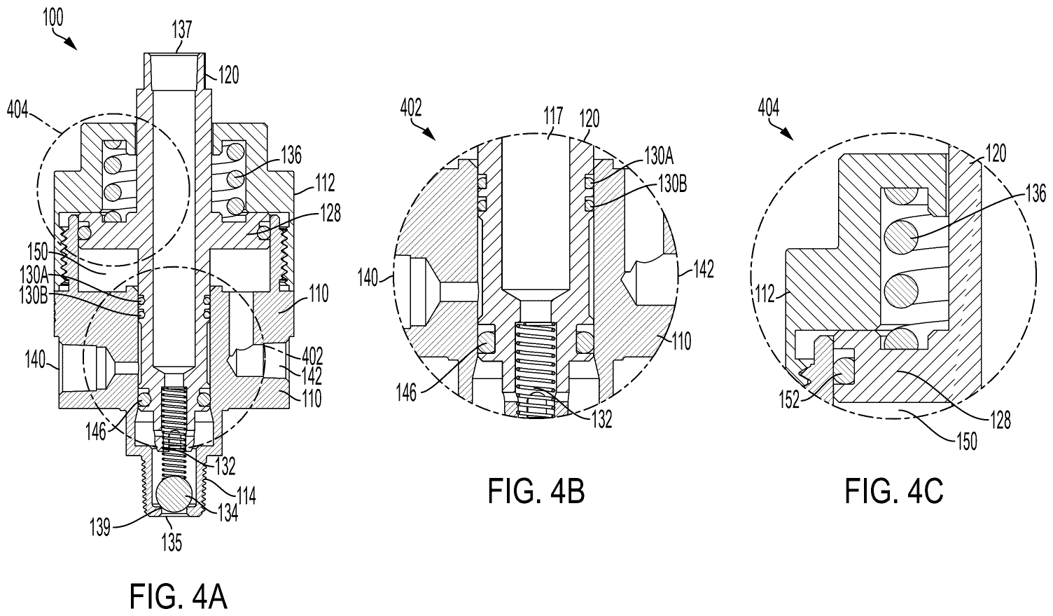

The valve stem 120 can move linearly (up and down) within the body of the VBV 100, and its lower end is in contact with the ball 134. The VBV 100's two sets of springs, the upper compression spring 136 and the lower compression spring 132 work in tandem with an integrated pressure cylinder 150 (shown in FIGS. 3A and 4A) operated by the air piston 128 that is integrated with valve stem 120, to manipulate the position of the valve stem 120 and control the opening and closing of the VBV 100 so as to allow, or prohibit, the flow of air and resin through the valve, as explained in further detail hereafter.

When the VBV 100 is in its closed position (which may be referred to as its “normal” or “non-energized” state), the upper compression spring 136 attempts to expand to its equilibrium position. In so doing, it imposes a downward force against the air piston 128, which is integrated with valve stem 120. This downward force is not opposed by the lower spring 132 and is transferred to the ball 134, with the valve stem 120 pressing ball 134 tightly against the vent port interface 139 and sealing the vent port entry closed so that neither air nor resin can enter the VBV 100.

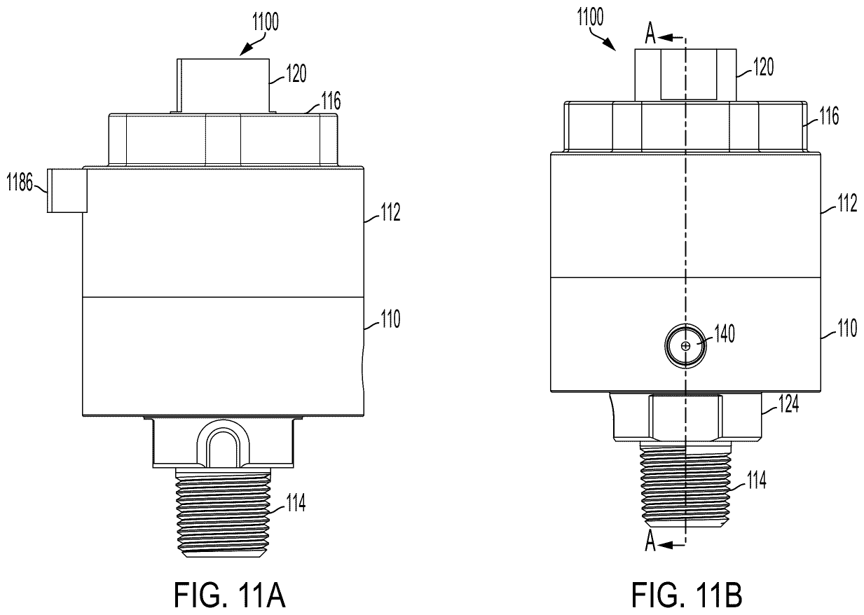

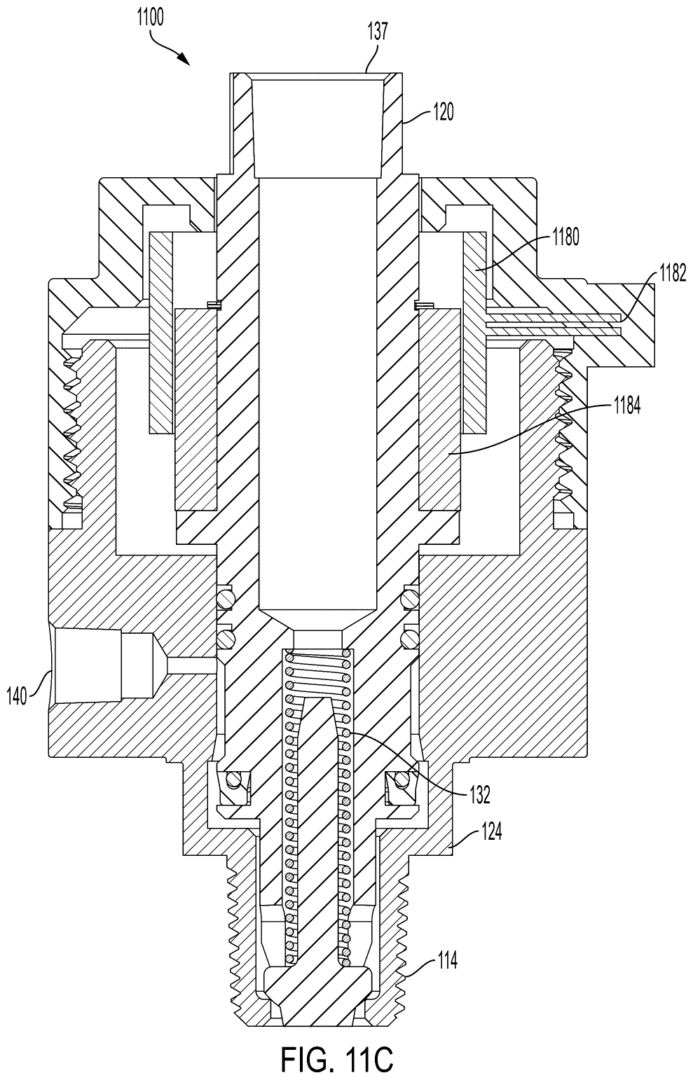

The “bleeding” operation in which air is removed from the mold activates when VBV 100 is opened by compressing compression spring 136. (This may be referred to as the “energized” state of the VBV.) In the preferred embodiment of FIG. 1, that compression is accomplished by supplying air pressure to air port 142, which exerts pressure on air piston 128 and causes the integrated valve stem 120 and air piston 128 to rise, thereby compressing the helical compression spring 136 until it reaches a dead stop against the inner surface at the top of assembly cap 116. In an alternative embodiment (as shown in FIG. 11C), the same effect is achieved via electrification of winding 1180.

The lower compression spring 132 presses the ball 134 against the vent port interface 139. Raising the valve stem 120 causes the lower compression spring 132 to stretch upwards. This action sets the height and subsequent force of the lower compression spring 132, which is in contact with ball 134, to an amount of force (the “set point”) selected to create a bleeder valve effect, allowing the passage of air but not liquid through the vent port interface 139. While the force remains at the set point, the ball 134 is pressed against the vent port interface 139 to an extent that allows air bubbles to pass into the VBV 100 but prevents resin from passing the ball 134 until the liquid pressure of the resin in the mold exceeds the force of the lower compression spring 132.

When liquid pressure of the resin in the mold increases above the set point, the lower compression spring 132 is pushed upward and no longer presses the ball 134 so firmly against the vent port interface 139. The lower spring 132 and the ball 134 thus create an opening at vent port interface 139 that is large enough to now allow not only air but also resin to pass out of the mold and into the VBV 100. Resin will continue to pass into the VBV 100 until the system liquid pressure has been reduced to the set point and the lower compression spring 132 once again presses against the ball 134 with sufficient pressure to halt the flow of liquid. This feature helps prevent the build-up of dangerous pressure levels within the mold.

A diametric seal 130A and a diametric seal 130B are designed to create a tight seal around the cylindrical surface of the valve stem 120, ensuring that resin and air do not escape around its sides during the molding process. In addition, when the VBV 100 lifts the lower compression spring 132, an integrated purge seal 146 is compressed. This compression provides an additional diametric seal, working in conjunction with diametric seals 130A and 130B. Together, these seals create a tight seal around the cylindrical surface of the valve stem 120, ensuring that resin or air does not escape during the molding process.

After the bleeding operation is completed, the air pressure supplied to air port 142 is removed (or electrification of the winding 1180 is removed as seen in FIG. 11C). Compression spring 136, with no opposing force preventing motion, imposes a force against the air piston 128, closing VBV 100 and directly transferring the force to the ball 134.

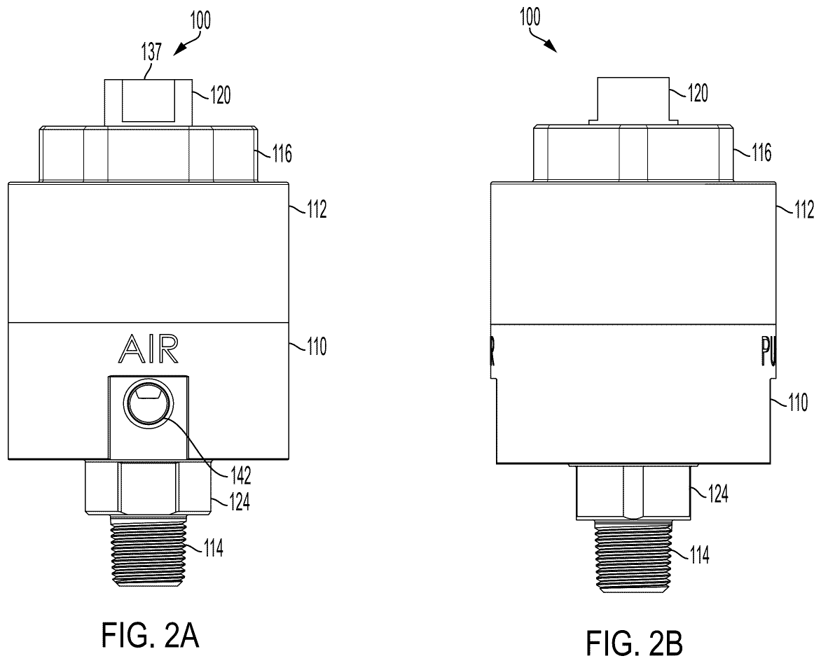

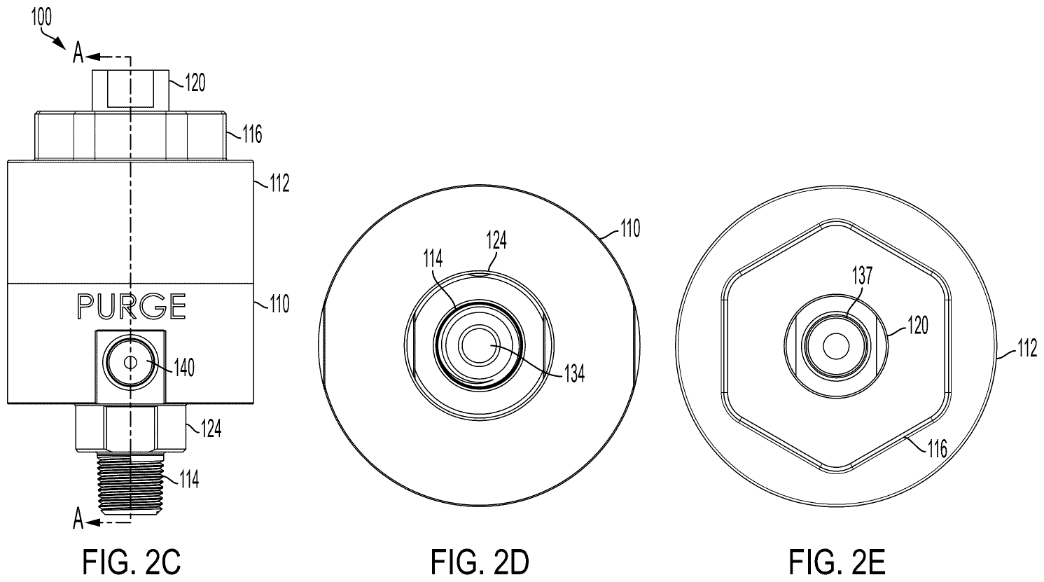

Referring now to FIGS. 2A-2E, these Figures illustrate the exterior of the VBV 100. FIG. 2A is a front elevation view of the VBV 100 and shows the air port 142. FIG. 2B is a side elevation view of the VBV 100 showing the main assembly body 110, assembly cap 112, external-threated connector 114, socket cap feature 116, valve stem 120, and wrench flat feature 124. FIG. 2C illustrates a rear elevation view of the VBV 100, which includes the purge port (cleaning) element 140. FIGS. 2D and 2E illustrate the bottom view and top view, respectively, of the VBV 100.

Referring now to FIGS. 3A-3C, FIG. 3A shows a sectional view of VBV 100 in its normally closed configuration, unenergized, taken along line A-A from FIG. 2C. FIG. 3A also displays the air port 142 and the purge port (cleaning) element 140, which allows for cleaning and purging VBV 100 of excess liquid. FIG. 3A's detailed highlight 302 is depicted in FIG. 3B. FIG. 3A's detailed highlight 304 is depicted in FIG. 3C. FIG. 3B is a detailed sectional view (302) that illustrates the details of the VBV 100 inner assembly, featuring the components, lower check seal 146, and diametric seals 130A and 130B. FIG. 3C is a detailed sectional view (304) that illustrates the details of the VBV 100 inner assembly, featuring the components, external-threaded base connector 114, lower portion of wrench flat feature on main body 124, ball 134, vent port entrance 135, and vent port interface 139.

Referring now to FIGS. 4A-4C, FIG. 4A shows a sectional view of the VBV 100 in its energized state. As can be seen, the valve stem 120 has been pushed upward and the top of the valve stem 120 is noticeably higher above the top of the assembly cap 112 than is the case in the unenergized VBV 100 that was shown in FIG. 3A. Similarly, it can be seen that the lower compression spring 132 is stretched upward, while the upper compression spring 136 is compressed. FIG. 4A also displays elements including the purge port (cleaning) 140, air port 142, integrated purge seal 146, and the integrated pressure cylinder 150. The detailed highlight 402 in the lower section of FIG. 4A is depicted in the sectional view of FIG. 4B, while the detailed highlight 404 in the upper section of FIG. 4A is depicted in the sectional view of FIG. 4C, illustrating the detailed components of the upper section of VBV 100, which includes an air seal 152.

Referring now to FIGS. 5A-5B, FIG. 5A shows a sectional view of an alternative configuration 500 of the VBV 100, featuring a poppet element instead of a ball element. In addition in this alternate embodiment, the air piston 128 and the valve stem 120 are not formed as a single unit but are formed separately and adapted to work cooperatively in the same manner as the integrated embodiment described with respect to FIG. 1. FIG. 5B shows the detail highlight 502, which illustrates the details in the lower port entrance, featuring poppet 534 as a normally closed angled poppet having a squared edge configuration.

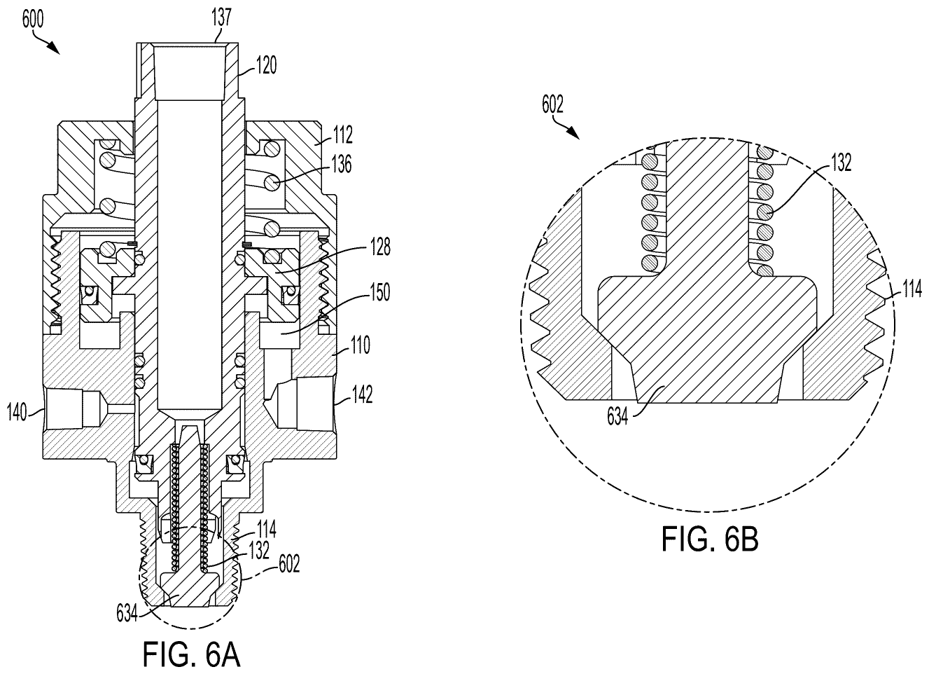

Referring now to FIGS. 6A-6B, FIG. 6A shows a sectional view of another alternative configuration 600 of the VBV 100, featuring a poppet element 634 instead of ball element 134. FIG. 6B shows the detail highlight 602, which illustrates the details in the lower port entrance, featuring the poppet element 634 as a normally closed angled poppet with a chamfered edge configuration.

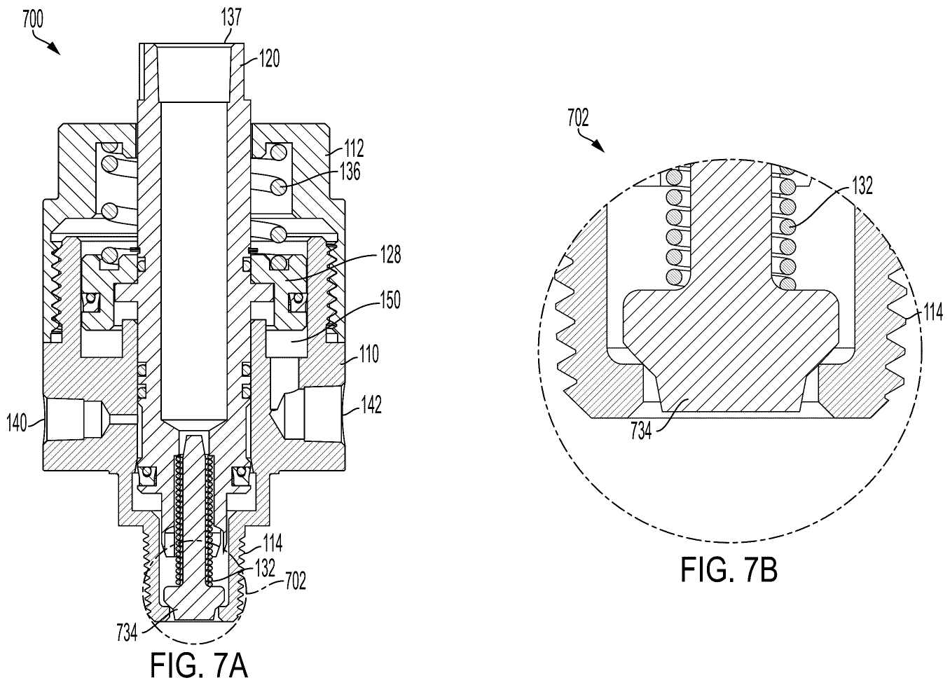

Referring now to FIGS. 7A-7B, FIG. 7A shows a sectional view of another alternative configuration 700 of the VBV 100, featuring a poppet element 734 instead of ball element 134. FIG. 7B shows the detail highlight 702, which illustrates the details of the lower port entrance, featuring the poppet element 734 as a normally closed spherical poppet having a squared edge configuration.

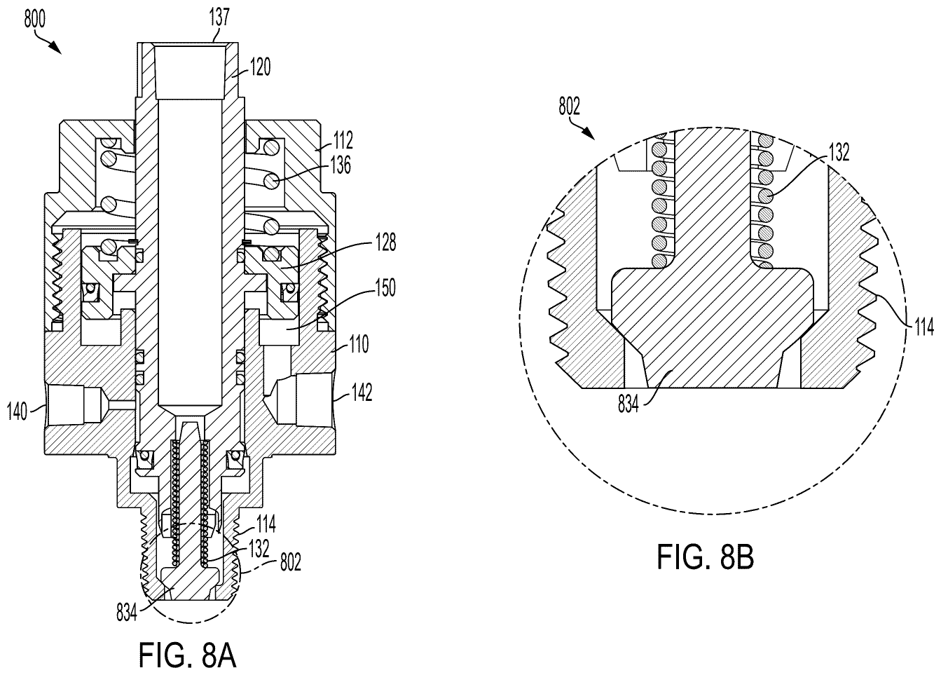

Referring now to FIGS. 8A-8B, FIG. 8A shows a sectional view of yet another alternative configuration 800 of the VBV 100, featuring a poppet element 834 instead of ball element 134. FIG. 8B shows the detail highlight 802, which illustrates the details of the lower port entrance, featuring the poppet element 834 as a normally closed spherical poppet having a chamfered edge configuration.

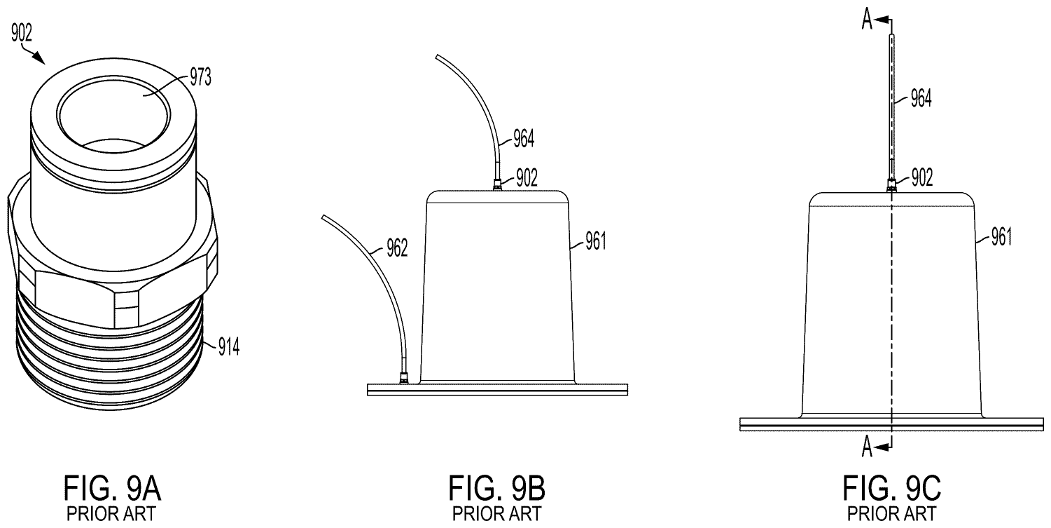

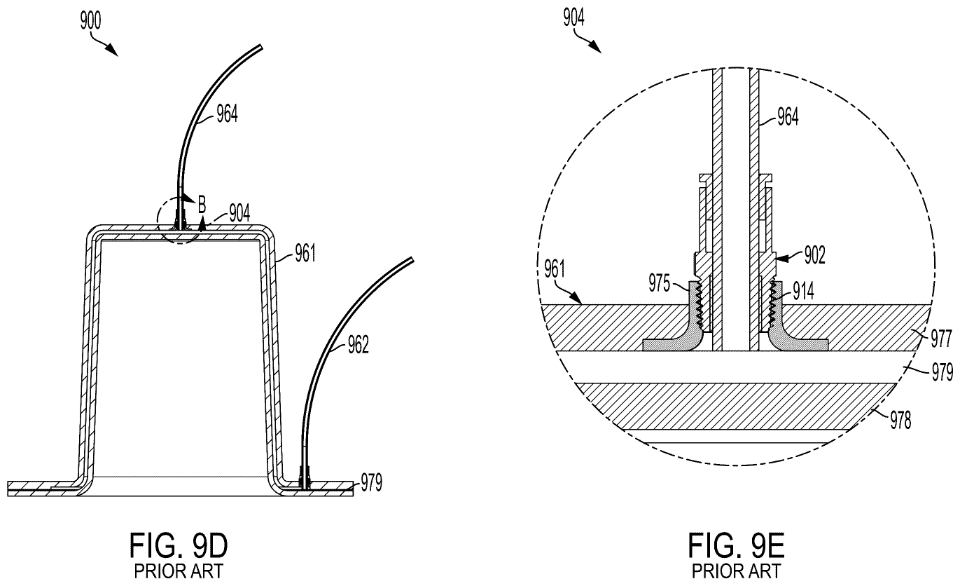

Referring now to FIGS. 9A-9E. FIG. 9A, these figures depict a conventional industrial set-up for venting resin transfer molds in the manner described in the Background section above. FIG. 9A shows a perspective view of a prior art push-to-connect vent tube fitting element 902, which the inventive VBV 100 replaces. FIG. 9A displays an interior 973 and a threaded base 914 of the element 902 push-to-connect vent tube fitting. FIG. 9B and FIG. 9C show elevation views that illustrate a prior art mold 961 for resin transfer molding, including prior art push-to-connect vent tube fitting 902, vent port exit tube 964, and resin injection tube 962. FIG. 9D is a configuration 900, illustrating a sectional view of a prior art mold 961 for resin transfer molding, taken along line A-A in FIG. 9C, illustrating the current industrial configuration, including the resin injection tube 962, the vent port exit tube 964, and a resin flow cavity 979. FIG. 9D further indicates detail area 904 for showing prior push-to-connect vent tube fitting, installed on a resin transfer mold. FIG. 9E shows the sectional view of the detail highlight 904 showing prior art push-to-connect vent tube fitting, installed on a resin transfer mold. FIG. 9E includes the prior art push-to-connect vent tube fitting 902, and the threaded base of element 902 prior art push-to-connect vent tube fitting 914. FIG. 9E further illustrates the mold 961 for resin transfer molding, including an upper section 977 of the mold, a lower section 978 of the mold, and the resin flow cavity 979 of the mold, and also shows the vent port exit tube 964 extending upwardly from the mold.

FIG. 10A is an elevation sectional view, depicting a preferred embodiment of the inventive VBV 100, shown inside detail area 1002, installed as it could be used on a conventional mold 961 for resin transfer molding. FIG. 10A depicts resin injection tube 962, vent port exit tube 1011, and the mold 961's resin flow cavity 979. FIG. 10B is an enlarged view of detail area 1002, providing a sectional view of a preferred embodiment of the inventive VBV 100, installed as it could be used on a conventional mold 961 for resin transfer molding. FIG. 10B shows the vent bleeder valve's external threaded base connector 114 installed into a conventional interior-threaded mounting base 975 of mold 961, which opens into the mold 961's resin flow cavity 979, thereby allowing access for resin and air to enter the inventive vent bleeder valve via vent port entrance 135, with such entry controlled by ball 134. FIG. 10B further shows the elements of vent bleeder valve 100 that are depicted in FIG. 1, along with connectors 1004 and 1005 fitted, respectively, to the air port 142 and purge port 140. An air inlet tube 1009 is, in turn, connected to the air port connector 1004, and a purge port exit tube 1007 is connected to the purge port connector 1005.

FIG. 11 illustrates an alternative embodiment, Vent Bleeder Valve 1100, which features a magnetic core 1184, winding 1180, and winding port 1182 within the valve's inner assembly. The valve 1100 is depicted in a front elevational view, a side elevation view, and a sectional view taken along line A-A in FIG. 11B.

The vent bleeder valve is preferably constructed of metal for durability. For example, anodized aluminum, chrome-plated steel, and stainless steel are all suitable materials. Seal materials can include, by way of example, fluorosilicone, silicone, fluorocarbon, and Viton. Persons of ordinary skill in the art will readily appreciate what other materials are suitable and may be substituted.

The precise shape of the elements used to block the passage of fluids through the vent port entrance 135 is not critical to the invention. The crucial factor is that the seal formed between the plug (for example, ball 134) and the body of the VBV 100 surrounding the vent port entrance at vent port interface 139 is substantially leak-free when the plug is in its closed position. While the primary embodiment depicts the use of a ball 135 that sets within a matching opening, alternative embodiments are depicted that use poppet-chamfered and spherical components (e.g. poppets 534, 634, 734, and 834); alternative configurations of the plug could include, by way of example, a face sealing valve, tapered sealing valve, diametric sealing valve, ball on the cone, and ball on the taper.

The principles, preferred embodiment, and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A resin transfer mold vent bleeder valve (VBV) device comprising:
an assembly cap;
an assembly main body;
a valve stem comprising a vent passageway;
an air piston;
an upper compression spring dead stop;
an upper compression spring;
a lower compression spring;
a plug;
a vent port entrance;
a vent port exit; and
a vent port interface.

2. The device of claim 1 further comprising:
a first diametric seal; and
a second diametric seal.

3. The device of claim 2 further comprising an integrated pressure cylinder.

4. The device of claim 1 wherein the plug is a ball.

5. The device of claim 1 wherein the plug is a poppet.

6. The device of claim 1 wherein said VBV is preassembled and inserted into a corresponding opening on a resin transfer mold that contains a channel passage for resin and allows resin to freely pass through the mold, and when the mold resin pressure increases above a set point, an opening is created between a vent port interface and the plug that allows resin to exit the mold via the vent passageway through the vent port exit, thus reducing the system liquid pressure to more acceptable levels and removal of entrapped air.

7. The device of claim 6 further comprising lower seals, upper seals, and diametric seals, an air port, a purge port, and an integrated pressure cylinder.

8. A resin transfer vent bleeder valve system for composite manufacturing, comprising:
a bleeder valve (VBV) configured to regulate air evacuation and resin flow during a resin transfer molding process;
an integrated pressure cylinder operatively coupled to the VBV to provide controlled resin injection and pressure stabilization;
a multi-stage sealing mechanism; and
an air piston movable within the VBV.

9. A resin transfer molding vent bleeder valve for attachment to a resin transfer mold, adapted to move from a normal (closed) configuration to an energized (open) configuration, comprising:
a body having a lower end and an upper end, comprising a main body and an assembly cap, and further comprising a connector for connecting the body to a resin transfer mold;
a vent port entrance at the lower end of the body and a vent port exit at the upper end of the body;
a vent port interface comprising the entryway from the vent port entrance into the body;
a plug, sized relative to the vent port interface so as to block the passage of air and fluids through the vent port interface when the vent bleeder valve is in its closed position, and movable from a point blocking the vent port interface when the vent bleeder valve is in its closed position to a point allowing only the passage of air, and to a further point allowing the passage of air and resin, when the vent bleeder valve is in its open position;
a valve stem having a lower end and an upper end, the valve stem comprising the vent port exit and a vent passageway extending downwardly through the body from the vent port exit to a point proximate the vent port entrance plug, the valve stem being configured to move linearly up and down within the body;
an air piston connected to the valve stem and configured to move linearly up and down within the body;
an upper compression spring housed at least in part within the assembly cap and having a dead stop against the assembly cap;
an air port comprising an air entry and a channel directing air into an opening in the body below the air piston; and
a lower compression spring surrounding a lower portion of the valve stem and touching, at its lower end, the plug, and
configured to apply pressure to the plug at a predetermined set point, when the vent bleeder valve is in its open position, so as to maintain the plug in a bleeder state allowing the passage of air but not resin through the vent port interface; and
configured to respond to pressure above the predetermined set point by compressing so as to apply less pressure to the plug, allowing the passage not only of air but of resin between the plug and the vent port interface; and
further configured to apply pressure to the plug, when the vent bleeder valve is in its closed position, sufficient to maintain the plug in a closed state blocking the vent port interface and preventing the passage of air therethrough.
